(19) United States
(12) Patent Application Publication
(10) Pub. No.: US 2026/0112708 A1
(43) Pub. Date: Apr. 23, 2026

(54) METAL-BASED BATTERIES WITH ENHANCED CYCLABILITY

(71) Applicant: Washington State University, Pullman, WA (US)

(72) Inventors: Jeffrey G. Bell, Pullman, WA (US); Anjaiah Sheelam, Pullman, WA (US)

(21) Appl. No.: 18/865,776

(22) PCT Filed: May 16, 2023
(86) PCT No.: PCT/US2023/022405

§ 371 Date: Nov. 14, 2024

Related U.S. Application Data
(60) Provisional application No. 63/346,763, filed on May 27, 2022.

(51) Int. Cl. H01M 10/42; H01M 4/38; H01M 10/26; H01M 50/70

(52) U.S. Cl. CPC H01M 10/4214; H01M 4/38; H01M 10/26; H01M 10/4235; H01M 50/70; H01M 2300/0005

(57) ABSTRACT

Metal-based batteries incorporating magnets to apply Lorentz force are disclosed herein. In one example, a zinc-bromine battery includes an aqueous electrolyte containing bromine (Br₂), bromine ion complexes, or bromine precursors, a plurality of zinc cations (Zn₂+), and a plurality of anions of bromine; a first electrode containing zinc (Zn); a second electrode in fluid communication with the first electrode via the aqueous electrolyte; and a magnet proximate to the first electrode and/or the second electrode. The magnet has a field strength to exert sufficient Lorentz force on the plurality of zinc cations (Zn₂+) such that the zinc cations (Zn₂+) forming a vortex proximate to a surface of the first electrode during galvanic charging and discharging of the zinc-bromine battery.

### CROSS-REFERENCE TO RELATED APPLICATION(S)

This application is a continuation of and claims priority to U.S. Provisional Application No. 63/346,763, filed on May 27, 2022, the disclosure of which is incorporated herein in its entirety.

### BACKGROUND

Safe, long lasting, and large-scale energy storage is attracting great interests due to the increasing application of electronic devices. Zinc-bromine (Zn—Br) is a promising battery technology that can potentially satisfy such requirements. A zinc-bromine battery is a rechargeable battery that relies on an electrochemical redox reaction between zinc (Zn)/Zn²⁺ and bromine (Br₂)/Br⁻ in an aqueous electrolyte of zinc bromide (ZnBr₂) to generate an electrical current at a theoretical cell voltage of 1.84 volts. For instance, a zinc-bromine battery can include an anode containing zinc (Zn) separated by a cell membrane in a non-flammable aqueous electrolyte (e.g., a solution of zinc bromide, ZnBr₂) from a cathode containing bromine (Br₂) or a non-corrosive form of solid bromine complexes.

During discharging, zinc (Zn) metal is oxidized into zinc cations (Zn²⁺) and dissolved at the anode to release electrons that flow through an external circuit:

$$Zn \to {Zn}^{2 +} + 2 {e}^{-}$$

while at the cathode, bromine (Br₂) accepts these electrons from the external circuit and is reduced to bromide anions (e.g., Br⁻) in the aqueous electrolyte:

$${Br}_{2} + 2 {e}^{-} \to 2 {Br}^{-}$$

As such, the overall cell reaction is as follows:

$$Zn + {Br}_{2} \to {Zn}^{2 +} + 2 {Br}^{-}$$

During charging, the process is reversed. Under an external voltage, bromide anions (e.g., Br⁻) are oxidized back to bromine (Br₂) at the cathode while (Zn²⁺) is reduced to zinc (Zn) metal and deposited on the anode.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Zinc bromine is a promising battery technology for energy storage because of several operating advantages over other types of metal-based batteries. Such operating advantages include high theoretical battery capacity (238.02 mAh/g), high energy density (438 Wh/kg), suitable ionic conductivity (1 S/cm), low component costs, non-flammability (e.g., via using an aqueous electrolyte), and high flexibility in manufacturing and recycling. Despite the foregoing operating advantages, certain operating challenges may impede the wide commercialization of zinc-bromine batteries, as discussed in more detail below.

First, cross diffusion of bromine (Br₂) and/or polybromide ions (Br₂)ₙBr−, n=1, 2, 3 . . . from the cathode to the anode in a cell may occur during operation. Cross diffusion generally refers to a diffusion of corrosive Br₂ or (Br₂)ₙBr⁻ ions across a cell membrane from the cathode to the anode of a cell to directly react with zinc (Zn) at the anode. During galvanic charge-discharge (“GCD”), some of the Br₂ or (Br₂)ₙBr⁻ ions in the aqueous electrolyte can diffuse across the cell membrane due to chemical gradients of such ions in the cell or other suitable reasons. The diffused Br₂ or (Br₂)ₙBr⁻ ions can then chemically react with zinc (Zn) at the anode, and thus leading to self-discharge and loss of reversible electrical capacity of the cell.

In addition, dendrite growth may occur at the anode of the cell during GCD cycling. For example, zinc dendrite growth may occur at the anode that can lower electrical efficiency of the cell or even cause a catastrophic cell failure. A metal dendrite is a metallic crystalline structure formed on and extending from an interface of a substrate, such as the anode of a zinc-bromine battery. For instance, the zinc dendrites can form whisker-like structures on the anode and extend into the electrolyte. It is believed that differences of interfacing metal-ion (e.g., Zn²⁺) concentrations near the anode can promote uneven metal (e.g., zinc) deposition on the anode surface during charging, and thus forming such metal dendrites. During GCD cycling, the depletion of zinc ions near the anode surface can further increase concentration overpotential to cause higher growth rates at the tip of the existing dendrites.

The rough specific surface area of metal dendrites can increase chemical and non-reversible reactions of zinc (Zn) with chemicals in the electrolyte. For example, zinc (Zn) can react with the electrolyte to evolute hydrogen and form zinc oxide (ZnO) or zinc hydroxide (Zn(OH)₂) passivation layers. As such, on repeated GCD cycling, zinc dendrites can produce non-reactive “dead zinc” that impedes coulombic efficiencies of the cell, and thus significantly reducing the reversible capacity. Zinc dendrites can also extend long enough to penetrate the cell membrane to cause internal short-circuit and a catastrophic failure of the cell. Such operating challenges are also common in other metal-based (e.g., lithium, sodium, potassium, vanadium, iron, cerium, etc.) flow (e.g., vanadium redox flow batteries) or non-flow batteries (e.g., lithium-ion, sodium-ion, zinc-ion, or zinc-air batteries).

Some strategies for suppressing bromine cross diffusion include the addition of complexing agents (e.g., methyl ethyl pyrrolidinum bromide or methyl ethyl morpholinium bromide), optimization of electrolyte properties, and the inclusion of ion-selective membranes. During operation, the complexing agents can form large complex molecules with bromine or polybromide ions such that the membrane can reduce or prevent the complex molecules from migrating toward the anode. However, such strategies can increase costs and complexity of the battery while reducing the electrical capacity because the complexing agents do not participate in the galvanic action of the cell.

Other strategies for mitigating zinc dendrite formation rely on modifying the electrode or electrolyte components or operating parameters of the cell. For example, to suppress zinc dendrite growth, surfactants can be added to the aqueous electrolyte; the anode structure can also be modified; or the current densities and potential thresholds of the cell can be adjusted. In addition, additives with lower redox potentials than zinc (Zn) can be used to form an electrostatic shield for reducing growth rates of zinc dendrites. Unfortunately, implementing the foregoing strategies can lead to reduction of the overall specific capacity of the zinc-bromine batteries.

Several embodiments of the disclosed technology can address at least some aspects of the foregoing operating challenges by applying Lorentz force in a battery to reduce or prevent cross diffusion of redox species (e.g., Br₃⁻/Br₂) from the cathode to the anode and/or metal dendrite (e.g., Zn dendrite) formation on the anode. As a result, reversible electrical capacities, cyclability, and energy efficiency of zinc-bromine or other types of metal-based batteries can be improved. In certain implementations, one or more permanent magnets can be suitably placed internal to the cell to exert Lorentz force on the redox species in the aqueous electrolyte, as discussed in more detail below. In other implementations, the applied Lorentz force can be generated using an electromagnet, a magnetic field generator, or other suitable components internal or external to the cell.

In one embodiment, a zinc-bromine battery or cell configured in accordance with aspects of the disclosed technology includes a cell enclosure housing an anode containing zinc (Zn), a cathode containing bromine (Br₂), bromine precursors (e.g., Br⁻, Br₃⁻, Br₅⁻, etc.), or a carbon supported complex such as tetrapropylammonium tribromide (TPABr₃), an aqueous electrolyte (e.g., a solution of zinc bromide (ZnBr₂)) in direct contact with the anode and cathode, and a cell membrane in the electrolyte and placed between the anode and cathode. The battery can also include a first magnet proximate to the anode and a second magnet proximate to the cathode. In certain examples, the first and second magnets can have the same or similar magnetic strength and/or polarity. In other examples, the first and second magnets can have different magnetic strengths or polarities suitable to exert sufficient Lorentz force on redox species proximate to the anode and cathode, respectively.

For instance, in one aspect, the first magnet can be configured to generate sufficient Lorentz force to zinc cations (Zn²⁺) in the aqueous electrolyte proximate to the anode. As discussed in more detail below, it has been observed that the exerted Lorentz force can at least partially homogenize zinc cations (Zn²⁺) concentrations proximate to the anode, and thus reducing or even preventing zinc dendrite formation during GCD cycling. In another aspect, the second magnet can be configured to generate sufficient Lorentz force on the bromide anions (e.g., Br⁻) proximate to the cathode such that the bromide anions (Br⁻) reside close to the cathode surface instead of migrating toward the anode, and thus reducing or preventing cross diffusion toward the anode.

During experimentation, it was observed that the first and second magnets can each generate magnetic flux gradients extending between the anode or cathode and the cell membrane, respectively. The magnetic flux gradient can cause charged redox species (e.g., Zn²⁺ and Br⁻) to undergo acceleration during GCD cycling and thus form vortexes proximate to a respective electrode surface. For example, the zinc cations in the aqueous electrolyte were observed to form a vortex proximate to the anode. The mixing action of the vortex is believed to reduce concentration heterogeneity of the zinc cations (Zn²⁺) resulting in generally dendrite-free zinc deposition on the anode during GCD cycling. In addition, it was also observed that the vortex at the cathode can induce the bromide anions (Br⁻) to reside close to the cathode surface and thus reducing or preventing cross diffusion. In one experiment, Scanning Electron Microscopy (“SEM”) images and Energy Dispersive X-ray analysis (“EDAX”) showed generally dendrite-free zinc deposition and low bromine (0.5 at. %) on the zinc anode and cathode with a 50±1 mT magnetic field. Operando UV-Vis spectroscopy measurements confirmed suppressed leaching of Br₃⁻ species into the aqueous electrolyte under 50±1 mT of magnetic field. In contrast, a cell without any applied magnetic fields suffered from severe leakage of Br₃⁻ species and loss of electrical capacity.

Though the first and second magnets may be placed individually proximate to the anode and cathode, respectively, in other embodiments, Lorentz force may be applied to the redox species in other suitable manners. In one example, a single magnet can be placed proximate to the anode or cathode of the cell. The single magnet can be configured to provide sufficient Lorentz force to redox species proximate to both the anode and cathode. In another example, a magnet can be placed external to the cell enclosure and between the anode and cathode to provide sufficient Lorentz force to the redox species inside the cell enclosure. In yet another example, the cell enclosure or an attachment thereto can be constructed with an at least partially magnetic material (e.g., a ferromagnetic material) to provide sufficient Lorentz force to the redox species internal to the cell enclosure.

Several embodiments of the disclosed technology can thus provide batteries that can retain reversible capacity and have long cycle life with high voltage and energy efficiency as well as rate capacity. It has been observed that magnets placed proximate to the electrodes of cells can exert sufficient Lorentz force to cause redox species in the electrolyte to form vortexes proximate to electrode surfaces during operation. The spinning action of the vortex at the anode can at least partially homogenize zinc cation concentrations proximate to the anode surface and thus reduce or prevent formation of zinc dendrites. The spinning action of the vortex at the cathode can keep bromide anions close to the cathode, and thus reducing the probability of diffusing across the cell membrane. By at least reducing metal dendrite formation and/or anion cross diffusion, batteries with improved performance can be attained.

### BRIEF DESCRIPTION OF THE DRAWINGS

FIGS. 1A-1F are schematic diagrams of zinc-bromine batteries incorporating one or more magnets to apply Lorentz force to redox species in an aqueous electrolyte in accordance with embodiments of the disclosed technology.

FIGS. 2A and 2B are schematic diagram illustrating example effects of the applied Lorentz force on redox species in the aqueous electrolyte in the zinc-bromine battery of FIGS. 1A-1F.

FIG. 3A is an example plot of open circuit voltage of a zinc-bromine battery generally similar to those of FIGS. 1A-1F with 0, 10±1, 30±1, 50±1 and 70±1 mT magnetic fields in accordance with embodiments of the disclosed technology.

FIG. 3B is an example plot of self-discharge profiles of the zinc-bromine battery of FIG. 3A after charging to 1 mA/cm² for one hour with a cut-off voltage of 2.2 Volts in accordance with embodiments of the disclosed technology.

FIG. 3C is an example three-dimensional plot of capacitive charge and diffusion-controlled charge contributions of the zinc-bromine battery of FIG. 3A at various scan rates and magnetic fields in accordance with embodiments of the disclosed technology.

FIGS. 3D and 3E are example plots of cell voltage with capacitive charge and diffusion-controlled charges, respectively, at 1.2 mV/s of the zinc-bromine battery of FIG. 3A in accordance with embodiments of the disclosed technology.

FIG. 3F is an example plot of the change in peak current densities and reversibility of redox process in a 0.5 M ZnBr₂ solution and a 0.5 M ZnBr₂+0.2 M tetrapropylammonium tribromide (TPABr₃) solution with 0 and 50±1 m in accordance with embodiments of the disclosed technology.

FIGS. 4A and 4D show operando UV-Vis spectra of TPABr₃ and Br₂ with known concentrations; FIGS. 4B and 4C show operando UV-Vis spectra of an example electrolyte while running a cell voltage at a scan rate of 0.6 mV/s at 18±2° C. without magnetic fields; FIGS. 4E and 4F show operando UV-Vis spectra of an example electrolyte while running cell voltage at a scan rate of 0.6 mV/s at 18±2° C. with a magnetic field of 50±1 mT in accordance with embodiments of the disclosed technology.

FIGS. 5A-5F are examples of a voltage efficiency plot, an energy efficiency plot for 100 GCD cycles at 1 C rate in an example zinc-bromine battery with 0, 10±1, 30±1, 50±1 and 70±1 mT magnetic fields, the respective 100th GCD polarization curve, the change in charge and discharge specific capacity with 0 and 50±1 mT at 0, 1 C, 1 C, 3 C and 5 C-rates, the charge and discharge specific capacity with 0 and 50±1 mT at 1 C, 2 C and 3 C-rates, and a comparison of respective 100th GCD cycle, respectively, in accordance with embodiments of the disclosed technology.

FIGS. 6A-6E are example morphology of zinc-electrodes after 100 GCD cycles of an example zinc-bromine battery with 0, 10±1, 30±1, 50±1 and 70±1 mT, respectively, in accordance with embodiments of the disclosed technology.

FIGS. 6F-6J are example cross-sectional views of the zinc electrodes in FIGS. 6A-6E showing an example passivation layer in accordance with embodiments of the disclosed technology.

FIGS. 7A-7C are example X-Ray Diffraction (“XRD”) patterns of the Zn electrodes in FIGS. 6A-6E after 100 GCD cycles in accordance with embodiments of the disclosed technology.

FIG. 8A shows an example Coulombic efficiency of an example zinc-bromine battery at 100th and 550th cycle with 0 and 50±1 mT while FIGS. 8B and 8C show respective zinc electrode morphology obtained after the GCD cycling in accordance with embodiments of the disclosed technology.

### DETAILED DESCRIPTION

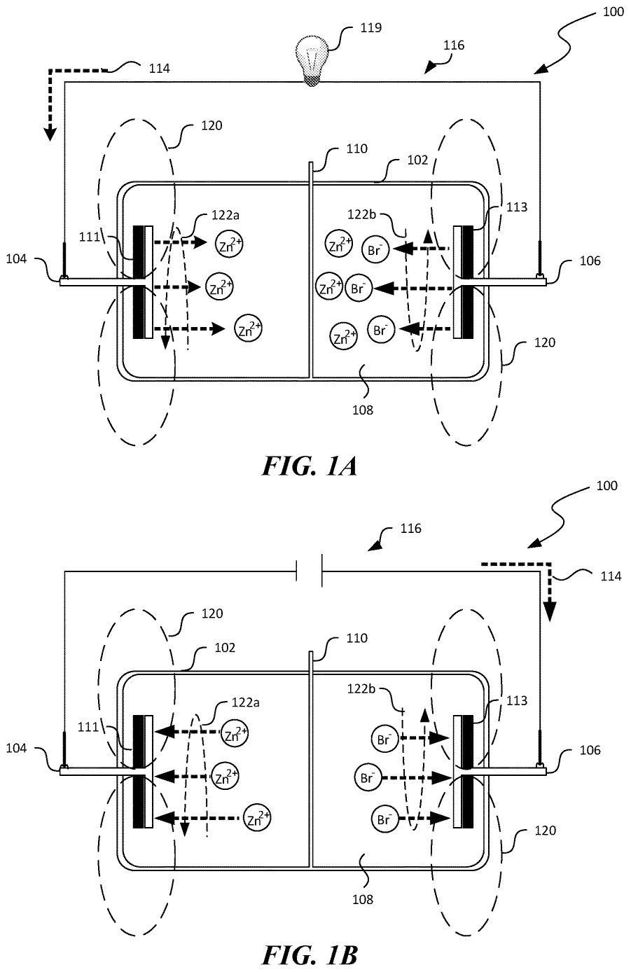

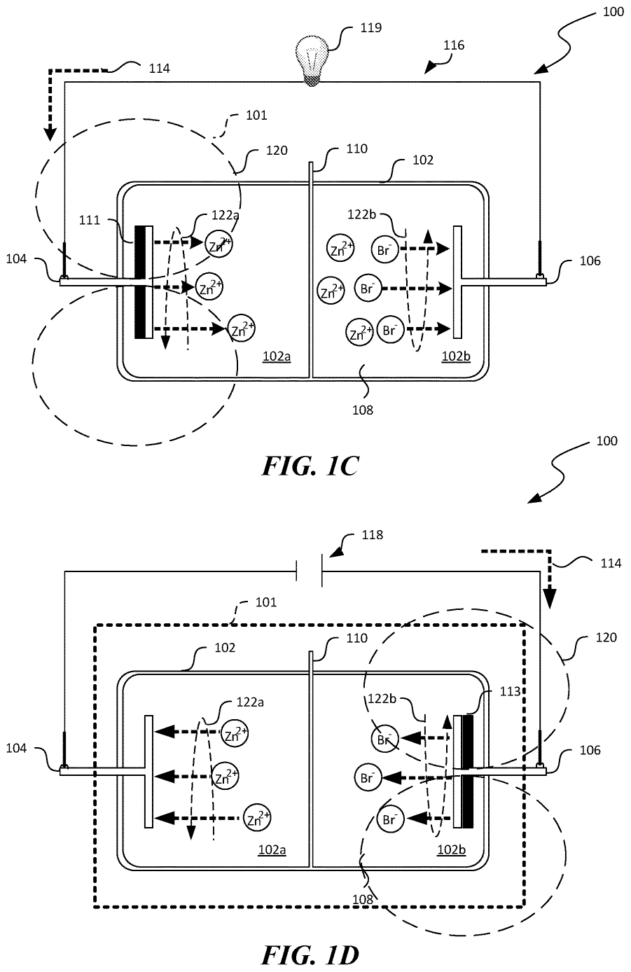

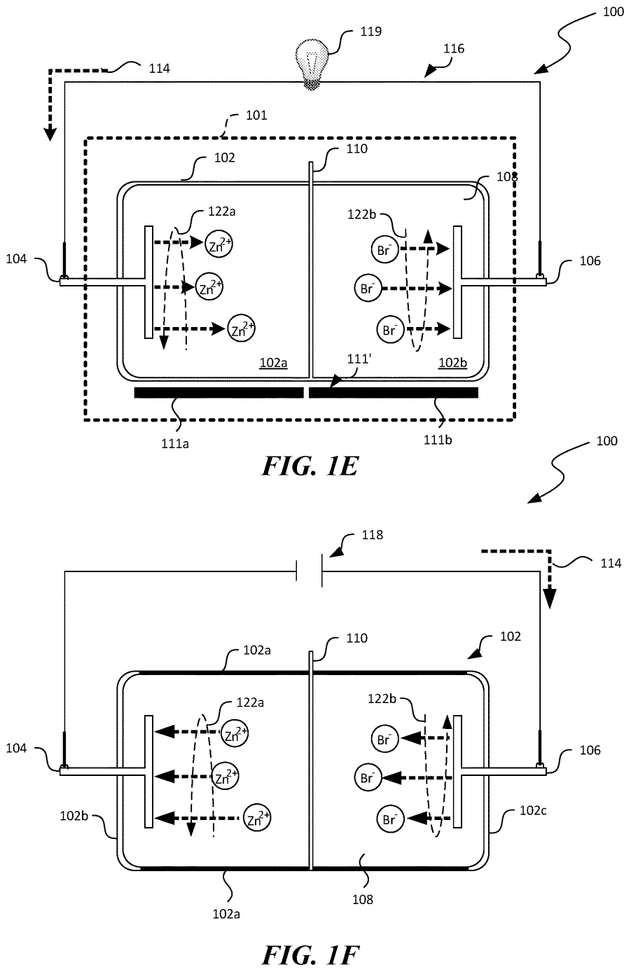

Various embodiments of metal-based battery systems, devices, and associated methods of making are described herein. Even though the technology is described below using a zinc-bromine battery as an example, in other embodiments, the technology may be applicable in other suitable types of metal-based batteries (e.g., containing lithium, sodium, potassium, calcium, magnesium, cadmium, or copper ions). In the following description, specific details of components are included to provide a thorough understanding of certain embodiments of the disclosed technology. A person skilled in the relevant art will also understand that the disclosed technology may have additional embodiments or may be practiced without several of the details of the embodiments described below with reference to FIGS. 1A-8C.

Zinc-bromine is a promising battery technology for energy storage because of certain advantages, such as high theoretical battery capacity, low component costs, and non-flammability over other types of metal-based batteries. Despite such advantages, operating challenges such as cross diffusion of bromine and zinc dendrite growth may impede the wide commercialization of zinc-bromine batteries. Though certain strategies exist that can at least ameliorate the foregoing operating challenges, the existing strategies can lead to reduction of overall specific capacities of the batteries or other undesirable outcomes.

Several embodiments of the disclosed technology can address at least some aspects of the foregoing operating challenges by applying Lorentz force in the cell to reduce or prevent cross diffusion of redox species (e.g., Br₃⁻/Br₂) from the cathode to the anode and/or metal dendrite formation on the anode. It has been observed during experiments that magnets placed proximate to the anode and cathode can exert sufficient Lorentz force to accelerate redox species in the electrolyte to form vortexes proximate to electrode surfaces during GCD. The spinning action of the vortexes at the anode can at least partially homogenize zinc cation concentrations proximate to the anode surface and thus reduce or prevent formation of zinc dendrites. The spinning action of the vortex at the cathode can also keep bromide or polybromide anions close to the cathode surface. As a result, the probability of the bromide or polybromide anions diffusing across the cell membrane toward the anode can be reduced or even prevented. The reduction or even prevention of zinc dendrite formation and/or cross diffusion of bromine can lead to retained reversible capacity, long cycle life, and high voltage efficiency, rate capacity, and energy efficiency of the battery, as discussed in more detail below.

FIG. 1A is a schematic diagram of an example zinc-bromine battery 100 during discharging, and FIG. 1B is a schematic diagram of the zinc-bromine battery 100 during charging in accordance with embodiments of the technology. As shown in FIGS. 1A and 1B, the zinc-bromine battery 100 can include a cell enclosure 102 housing an anode 104, a cathode 106, an aqueous electrolyte 108, and an optional cell membrane 110 in the aqueous electrolyte 108. The anode 104 and the cathode 106 are at least partially submerged in the aqueous electrolyte 108. Even though only certain components are illustrated in FIGS. 1A and 1B, in other embodiments, the zinc-bromine battery 100 can also include current collectors, insulators, gaskets, vent holes, springs, protective wrappings, and/or other suitable components (not shown). In further embodiments, the cell membrane 110 may be omitted.

The anode 104 can be made of or contain zinc (Zn), which is a highly reactive metal that readily gives up electrons to become positively charged zinc cations (Zn²⁺). As shown in FIG. 1A, during discharge, zinc (Zn) undergoes oxidation at the anode 104 to form zinc cation (Zn²⁺) while releasing electrons 114 (shown as an opposite current direction herein) that flow through an external circuit 116 to power devices, such as the light bulb 119. During charging, the process is reversed. Electrons 114 flow back from the external circuit 116 to the anode 104 to reduce zinc cations (Zn²⁺) to zinc metal to be deposited onto a surface of the anode 104, as shown in FIG. 1B.

The cathode 106 can be made of a porous carbon material, such as graphite or carbon felt. In certain embodiments, the cathode 106 can include high porous carbon/mesoporous carbon to adsorb bromine complex. In other embodiments, the cathode 106 can be constructed of or include other suitable materials. As shown in FIG. 1A, during discharge, the cathode 106 can accept electrons 114 from the external circuit 116 to convert bromine (Br₂) into bromide anions (Br⁻) or bromine ion complexes. During charging, the process is reversed. Bromide anions (Br⁻) release electrons 114 to the external circuit 116 via the cathode 106 and are converted to bromine (Br₂) and further transformed into polybromide ions.

In certain embodiments, the aqueous electrolyte 108 can include a solution of zinc bromide (ZnBr₂) in water. The aqueous electrolyte 108 can facilitate flows of ions between the anode 104 and cathode 106. For example, during discharge, the zinc cations (Zn²⁺) produced at the anode 104 have a natural tendency to migrate through the aqueous electrolyte 108 toward the cathode 106 while the bromine ions (Br⁻) tend to migrate toward the anode 104. This ion flow occurs naturally while allowing the electrons 114 to flow through the external circuit 116. During charging, the process is reversed, with the zinc cations (Zn²⁺) and bromide anions (Br⁻) switching places in the aqueous electrolyte to restore the original ion concentration gradients and enable the battery 100 to store energy.

The optional cell membrane 110 can be used to electrically separate the anode 104 and the cathode 106 while allowing flows of ions therebetween. In certain embodiments, the cell membrane 110 can include a cation exchange membrane that selectively allows positively charged ions, such as the zinc cations (Zn²⁺) to pass through while blocking negatively charged ions, such as bromide or polybromide anions (Br⁻)ₙ from crossing over. As such, the two half reactions of the cell can be prevented from directly interacting to maintain a stable performance over multiple GCD cycles. In other embodiments, the cell membrane 110 can include other suitable types of membrane or be omitted from the zinc-bromine battery 100.

Though the cell membrane 110 may limit the extent of bromide anions (Br⁻) crossing over from the cathode 106 to the anode 104, it has been recognized that certain amount of bromide anions (Br⁻) may diffuse cross the cell membrane 110 toward the anode 104 during GCD cycling due to chemical gradients in the zinc-bromine battery 100, electrostatic environment between the cathode 106 and anode 104, thermodynamic conditions in the zinc-bromine battery 100, or other reasons. Any diffused bromide anions (Br⁻) can then directly react with zinc (Zn) at the anode 104, leading to self-discharge and loss of reversible electrical capacity of the zinc-bromine battery 100.

In addition, zinc dendrite growth at the anode 104 can lower electrical efficiency of the zinc-bromine battery 100 or even cause a catastrophic failure. A metal dendrite is a metallic crystalline structure formed on and extending from an interface of a substrate, such as the anode 104. For example, the zinc dendrites can form whisker-like structures on the anode 104 and extend into the aqueous electrolyte 108. It is believed that differences of interfacing metal-ion (e.g., Zn²⁺) concentrations near the anode 104 can promote uneven metal (e.g., zinc) deposition on the anode surface during charging, and thus forming such metal dendrites. During GCD cycling, the depletion of zinc ions near the anode surface can further increase concentration overpotential to cause higher growth rates of dendrites.

The rough specific surface area of metal dendrites can increase chemical and non-reversible reactions of zinc (Zn) with chemicals in the aqueous electrolyte 108. For example, zinc (Zn) at the anode 104 can react with the aqueous electrolyte 108 to evolute hydrogen and form zinc oxide (ZnO) or zinc hydroxide (Zn(OH)₂) passivation layers. As such, on repeated GCD cycling, zinc dendrites can produce non-reactive “dead zinc” that impedes coulombic efficiencies of a cell, and thus significantly reducing the reversible capacity. Zinc dendrites can also extend long enough to penetrate the cell membrane 110 to cause internal short-circuit and a catastrophic failure.

Several embodiments of the disclosed technology can address at least some aspects of the foregoing operating challenges by incorporating one or more magnets configured to apply Lorentz force to redox species in the zinc-bromine battery 100 to reduce or prevent (i) cross diffusion of redox species (e.g., bromide anions) toward the anode 104 and/or (ii) formation of metal dendrite on the anode 104. For example, as shown in FIGS. 1A and 1B, the zinc-bromine battery 100 can include a first magnet 111 proximate to the anode 104 and a second magnet 113 proximate to the cathode 106. In other examples, the zinc-bromine battery 100 can include one of the first or second magnet 111 or 113 and/or other arrangements thereof, as described in more detail below with reference to FIGS. 1C-1F.

The first and second magnets 111 and 113 can include a permanent magnetic element that is ferromagnetic. In other words, the first and second magnets 111 and 113 can be magnetized and retain magnetization even after an external magnetic field imparting the magnetization is removed. In certain embodiments, the permanent magnetic element can contain a compound of iron, nickel, and cobalt that is sintered into an alloy and then magnetized by being exposed to a magnetic field. In other embodiments, the permanent magnetic element can include a magnet made from a compound of rare earth elements, such as neodymium, samarium, or dysprosium. In further embodiments, the permanent magnetic element can include other suitable types of magnets.

As shown in FIG. 1A, in one aspect, the first magnet 111 can be configured to generate sufficient Lorentz force (as represented by dashed magnetic field lines 120) to zinc cations (Zn²⁺) in the aqueous electrolyte 108 proximate to the anode 104. As discussed in more detail below, it has been observed that the exerted Lorentz force can at least partially homogenize zinc cations (Zn²⁺) concentrations near surfaces of the anode 104 and reducing or even preventing zinc dendrite formation during GCD cycling. In another aspect, the second magnet 113 can be configured to generate sufficient Lorentz force to the bromide anions (Br⁻) proximate to surfaces of the cathode 106 such that the bromide anions (Br⁻) reside close to the cathode surface instead of migrating toward the anode 104, and thus reducing or even preventing cross diffusion of bromine or polybromide ions toward the anode 104.

The first and second magnets 111 and 113 can be configured to individually generate sufficient magnetic flux gradients extending from the cell membrane 110 to the anode 104 or cathode 106, respectively. The generated magnetic flux gradient can cause charged redox species, such as zinc cations (Zn²⁺) and bromide anions (Br⁻) to undergo acceleration or other movements during GCD cycling to form vortexes 122 (shown as first vortex 122a and second vortex 122b with dashed arrows) proximate to a respective electrode surface. For example, the zinc cations (Zn²⁺) in the aqueous electrolyte 108 can be induced to form the first vortex 122a proximate to the anode 104. It is believed that the mixing action of the first vortex 122a can reduce concentration heterogeneity of the zinc cations (Zn²⁺) in the aqueous electrolyte, and thus resulting in generally dendrite-free zinc deposition on the anode during GCD cycling.

In addition, the second vortex 122b at the cathode 106 can induce the bromide anions (Br⁻) to reside close to the cathode surface and thus reducing or preventing cross diffusion of the bromide anions (Br⁻) toward the anode 104. As discussed in more detail below with the Experiment Section, SEM images and EDAX showed generally dendrite-free zinc deposition and low bromine (0.5 at. %) on the anode 104 with a 50±1 mT magnetic field. Operando UV-Vis spectroscopy measurements confirmed suppressed leaching of bromide anion species into the aqueous electrolyte 108 under 50±1 mT of magnetic field. In contrast, a zinc-bromine cell without any applied magnetic fields suffered from severe leakage of bromide anion species and loss of electrical capacity.

In certain embodiments, the magnetic strengths of the first and second magnets 111 and 113 can be determined experimentally. It is believed that a magnetic strength sufficient to reduce or prevent cross diffusion and/or metal dendrite formation may be different based on various factors such as the chemical composition of the aqueous electrolyte 108, composition and structure of the anode 104 and/or cathode 106, the arrangement of the anode 104 and/or cathode 106, and/or other suitable factors. As discussed in the Experiment section below, the effect of the first and second magnets 111 and 113 on cross diffusion and metal dendrite growth may present a parabolic trend. As such, an optimal magnetic strength may be determined experimentally based on OCV or other suitable tests of sample cells. In other experiments, the magnetic strengths of the first and second magnets 111 and 113 may be determined theoretically or in other suitable manners.

Though the first and second magnets 111 and 113 are shown being placed individually near or next to the anode 104 and cathode 106, respectively, and internal to the cell enclosure 102, in other embodiments, Lorentz force may be applied to the redox species in other suitable manners. For instance, in one example, as shown in FIG. 1C, a single magnet 111 can be placed near or next to the anode 104. In another example, as shown in FIG. 1D, another single magnet 113 can be placed near or next to the cathode 106. In either configuration, the single magnet 111 or 113 can be configured to provide sufficient Lorentz force to redox species in the aqueous electrolyte 108 near or next to both the anode 104 and cathode 106. For instance, the single magnet 111 in FIG. 1C can have a magnetic strength to generate a sufficient magnetic flux gradient in both the anode compartment 102a and the cathode compartment 102b to cause the redox species to form vortexes.

In a further example, as shown in FIG. 1E, a magnet 111′ can be placed external to the cell enclosure 102 and between the anode 104 and cathode 106 to provide sufficient Lorentz force to the redox species in the aqueous electrolyte 108 inside the cell enclosure 102. In the illustrated embodiment, the magnet 111′ includes a first section 111a corresponding to the anode compartment 102a and a second section 111b corresponding to the cathode compartment 102b. In other embodiments, the magnet 111′ can include a single section, three sections, or any other suitable number of sections. In one implementation, the magnet 111′ can be affixed to the cell enclosure 102 by fasteners (not shown), glue, compression, or via other suitable techniques. Optionally, the battery 100 can further include a casing 101 that surrounds the cell enclosure 102 and the magnet 111′ external to the cell enclosure 102.

In yet another example, as shown in FIG. 1F, the cell enclosure 102 can be constructed with an at least partially magnetic material (e.g., a ferromagnetic material) to provide sufficient Lorentz force to the redox species in the aqueous electrolyte 108 internal to the cell enclosure 102. In the illustrated embodiment in FIG. 1F, the cell enclosure 102 includes a sidewall 102a extending between two ends 102b and 102c. Only the sidewall 102a is constructed from an at least partially magnetic material. In other embodiments, at least one of the ends 102b or 102c can also be constructed from an at least partially magnetic material. In further embodiments, only one of or both the two ends 102a and 102b can be constructed from an at least partially magnetic material.

Several embodiments of the disclosed technology can provide zinc-bromine or other suitable types of metal-based batteries that can retain reversible capacity and have long cycle life and high voltage efficiency, rate capacity, and energy efficiency. It has been observed that magnets 111 or 113 placed proximate to the anode 104 and cathode 106 can exert sufficient Lorentz force to accelerate redox species in the aqueous electrolyte 108 to form vortexes 122 proximate to electrode surfaces during GCD cycling. The spinning action of the vortexes 122 at the anode 104 can at least partially homogenize zinc cation concentrations proximate to the anode surface and thus reduce or prevent formation of zinc dendrites. The spinning action of the vortex 122 at the cathode 108 can also keep bromide or polybromide anions close to the cathode surface. As a result, the probability of the bromide or polybromide anions diffusing across the cell membrane 110 toward the anode 104 can be reduced or even prevented. By reducing or preventing zinc dendrite formation and cross diffusion, the battery 100 can retain reversible capacity, have long cycle life, and maintain high voltage efficiency, rate capacity, and energy efficiency.

### EXPERIMENTS

Certain experiments to study the impact of incorporating permanent magnets in metal-based batteries were performed with zinc-bromine batteries configured generally similar to those shown in FIGS. 1A-1D. Details of the experiment material, procedures, and description of results are discussed in more detail below. Materials

Materials used during the experiments included zinc bromide (ZnBr₂), TPABr, polyvinylidene fluoride activated carbon, glass microfiber filters 0.25 mm thick stainless steel current collectors, a 12.7 mm diameter stainless-steel rod, 0.85 mm thick titanium plate, and nickel coated 1 mm thick Neodymium magnets.

### Preparation of TPABr₃ Complex

Tribromide (Br₃⁻) solution was prepared by mixing 3 mL of 2 M H₂SO₄ and 3 mL of 2 M KBr with 4 mL of 0.1 M NaBrO₃ in a 10 mL glass vial. Then, 1 mL of H₂O and 1 mL of 1 M TPABr were added to the formed Br₃⁻ solution. The TPABR₃ complex was filtered and stored at room temperature for later use.

### Fabrication and Electrochemical Testing of Aqueous Zinc-Bromide Batteries

A half inch diameter Zn foil (0.2 mm thickness) was used as a negative electrode. A glass fibre of 0.7 μm pore size membrane was used as a separator or cell membrane. A combination of TAPBr₃⁻ complex, activated carbon, poly(vinylidene fluoride), and mesoporous carbon was mixed in dimethylformamide (DMF) with a mass ratio of 6:2:1:1, respectively. The prepared slurry was casted as a thin film on a titanium plate followed by drying in the air for 12 hours at 20° C. The overall loading of the cathode material was maintained to be 15 mg cm−2. Thus, prepared electrode was used as a positive electrode in zinc-bromide batteries.

An amount of 38 μL of 0.5 M ZnBr₂+0.2 M TPABr electrolyte was added to the glass fibre separator during battery assembly. One-millimetre-thick Nd magnetic disk (maximum of seventy-three mT) was placed behind each electrode. The desired magnetic field was attained by placing titanium plates in between the electrode and the magnet. The amount of TPABr additive in the 0.5 M ZnBr₂ was varied (0, 0.1 and 0.2 M). Fabricated cells were left for 35 hours to attain a stable open-circuit potential (OCV). The cells were then subjected to electrochemical testing (e.g., cyclic voltammetry, circuit potential, and GCD) profiles. The cut-off voltages for battery were set to be 1.0 V to 2.2 V.

### Results and Discussion

### Lorentz Force-Driven Ion Transport

The movement of a charged species (e.g., electrons, protons, or ions) in a magnetic field can be deviated into a circular path by Lorentz force. The equation below represents Lorentz force in the −z-direction on a negatively charged species:

$$\vec{F} = q ( \vec{E} + \vec{v} \hat{y} \times \vec{B} \hat{x} )$$

where q is the charge of an electron or ion in the electrolyte, \vec{E} is the electric field, \vec{v} is the velocity of the electron or ion, and \vec{B} is the magnetic field. Due to Lorentz force, negatively charged species move in the −z-direction and positively charged species move in z-direction. A sufficiently strong magnetic field can generate a synchronized circular path.

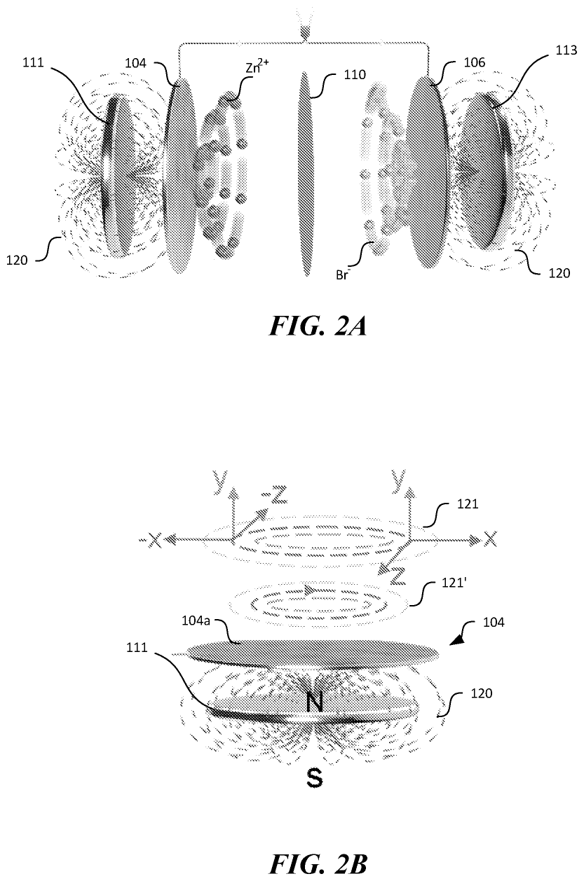

As shown in FIG. 2A, it was observed that Lorentz force induced ion movement or convection is also known as the magnetohydrodynamic effect. FIG. 2B illustrates a spiral flow of Zn²⁺ ions in the presence of a magnetic field. The magnetic field lines 120 are believed to be nearly circular on the magnet surface and travel from North to South-pole. As such, only the top point of the circular field line 120 is believed to contribute to the maximum cross product. Therefore, at any distance from the magnet surface, one intense circle 121 or 121′ is shown to reflect the magnitude of Lorentz force on Zn²⁺ ions. As shown in FIG. 2B, as the Zn²⁺ ions approach the anode surface 104a, the diameter of the intense circle 121′ decreases.

In configurations without magnetic fields, due to the polarity of electrodes, Zn²⁺ Br⁻ and polybromide ions would move during discharging to opposite compartments and cause electrical capacity loss. Applying symmetric magnetic fields (equal strengths at anode and cathode) can at least reduce the linear motion of ions due to Lorentz force-induced spiral flow and effectively inhibit the cross diffusion. While charging, Zn dendrite growth can also be reduced or even prevented due to electrolyte homogenization caused by the spiral flow of ions and increased concentrations of additive cations (e.g., TPA⁺). During both the discharging and charging, Lorentz force can effectively suppress the cross diffusion while simultaneously reducing or even preventing Zn dendrite growth.

To investigate the effect of Lorentz force on Zn dendrite growth, Br₃^{- or Br}₂ cross diffusion, and self-discharge rate of zinc-bromide batteries, cells were constructed by including magnetic field strengths of 10±1, 30±1, 50±1 and 70±1 mT at both electrodes. After fabrication, cells remained under rest for 35 hours to attain a stable OCV before electrochemical evaluation.

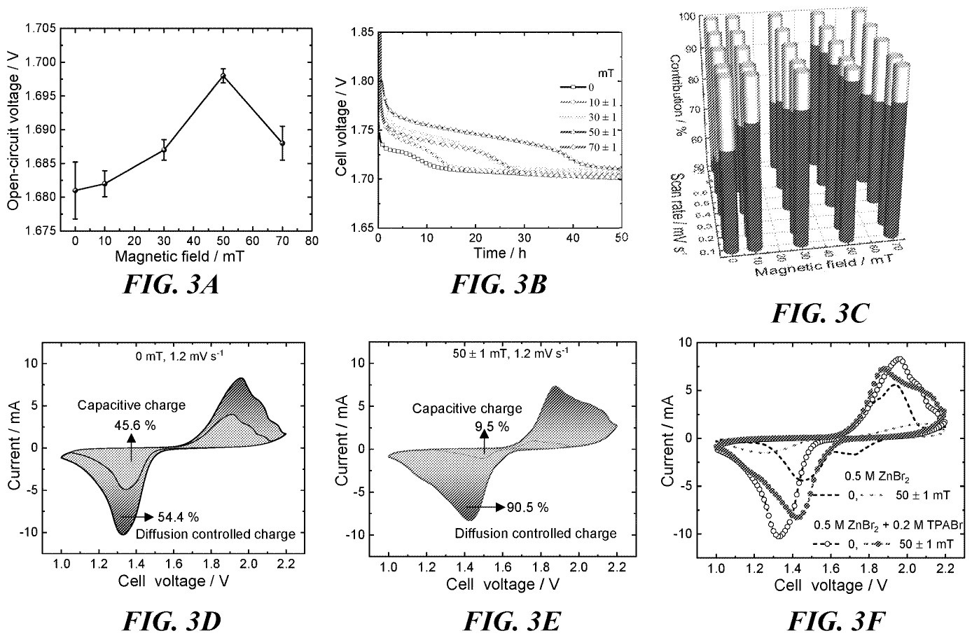

FIG. 3A shows observed example results of OCV of zinc-bromide batteries with applied magnetic fields of 0, 10±1, 30±1, 50±1 and 70±1 mT on the surface of the electrodes in accordance with embodiments of the disclosed technology. A gradual increase in the cell OCV was observed with increasing magnetic field from 0 to 50±1 mT, followed by a decrease in OCV when the magnetic field was increased to 70±1 mT. The highest OCV of 1.697±0.0010 V was found at 50±1 mT. The lowest OCV, 1.681±0.0040 V was observed on the cell without any applied magnetic field. The observed cell OCVs for cells with 10, 30, and 70±1 mT, magnetic fields were 1.682±0.0022 V, 1.687±0.0015V, and 1.688±0.0025 V, respectively.

Two open-circuit parasitic reactions are believed to occur to potentially decay voltage of a cell: (i) dissolution of electrode materials; and (ii) passivation layer formation. The dissolution of Zn can be followed by hydrogen evolution. Because of the mild acidic nature of electrolytes (pH=5.4), hydrogen gas evolution may be a parasitic loss. Consequently, the local pH of the electrolyte near the electrode/electrolyte interface can increase, which leads to the formation of a passivation layer (e.g., Zn(OH)₂ or ZnO).

At the cathode, dissolution of Br₂ and Br₃⁻ species followed by cross diffusion to the Zn anode is another challenge. The direct chemical reaction between Br₂ and Zn metal leads to a significant and irreversible loss of capacity. Under a magnetic field, electrolyte ions (e.g., Zn²⁺, TPA⁺ and Br⁻) experience Lorentz force and reside near to the anode surface. As such, the Zn|Zn²⁺ interface would retain Zn²⁺ ions, leading to a positive shift in the redox potential of Zn/Zn²⁺. The process can thus establish an equilibrium without further dissolution of Zn metal and/or hydrogen evolution. Similarly, the Br₃⁻|Br₂, Br⁻ interface can be expected to suppress the Br₂ and Br₃⁻ dissolution. However, further increasing the magnetic field may induce a stronger Lorentz force on ions that may increase the local TPA⁺ concentration relatively more than Zn²⁺ which may cause an unfavorable interface.

To further study the effect of Lorentz force on the transport of ions and parasitic capacity losses of battery cells, self-discharge rate studies were carried out on the example zinc-bromide batteries. Furthermore, the Zn anode surfaces were subjected to EDAX analysis to determine and estimate the oxygen and cross-diffused bromine amount.

Initially, the sample cells were subjected to a discharge followed by a charge at a current density of 1 mA cm⁻² for 1 hour with a cut-off voltage of 1.0 V to 2.2 V. Then, the sample cells remained at rest and were monitored until all cells reached a stable cell voltage. The decay of cell voltage as a function of rest time is shown in FIG. 3B. As shown in FIG. 3B, the sample cell without any applied magnetic field took only 12 hours, whereas the sample cell with 50±1 mT took 43 hours before reaching a stable voltage. Sample cells with 10±1, 30±1 and 70±1 mT retained charge for 15, 29 and 30 hours, respectively. Overall, the sample cell without any applied magnetic field underwent significant self-discharge, indicative of the cross diffusion of soluble Br₂ and/or Br₃⁻ species and a direct chemical reaction with the Zn anode. On the other hand, the presence of applied magnetic fields significantly suppressed such cross diffusion. A gradual decrease in self-discharge time was observed for the cells with 10±1, 30±1 and 50±1 mT. Interestingly, the cell with 70±1 mT displayed a faster voltage decay (30 h) than that of the cells with 50±1 mT (43 h).

The trend in the self-discharge rate appears to be similar to the OCV trend. During charging, Br⁻ ions were oxidized to a highly soluble Br₃⁻ species, which increases the Br₃⁻ concentration at the cathode. As such, the concentration gradient is believed to drive the Br₃⁻ ions without a net current load or potential applied to a sample cell. Thus, the transport of Br₃⁻ ions may cause severe self-discharge of the sample cells. However, the movement of Br₃⁻ ions due to concentration gradients appeared to be suppressed in the presence of magnetic fields.

After the self-discharge study, the sample cells were deconstructed, and Zn anodes were subjected to EDAX analysis. It was observed that the Zn anode surface under 50±1 mT magnetic field contained the least amount of bromine and oxygen compared to that of the 0 mT and other magnetic field strengths. Also, the slightly yellow color (TPABr₃) was observed on the Zn anode of the sample cell with 0 mT, whereas the sample cells with magnetic fields showed no yellow color. The estimated bromine at. % were 1.7, 1.5, 1.1, 0.5, and 2.7% at 0, 10±1, 30±1, 50±1 and 70±1 mT, respectively. Only 14.3 at. % of oxygen was found on the Zn anode surface of the example zinc-bromide battery with a 50±1 mT magnetic field, whereas 24.6, 18.1, 15.2 and 32.8 at. % was found on the Zn anodes with 0, 10±1, 30±1 and 70±1 mT, respectively. The presence of oxygen is believed to indicate formation of ZnO or Zn(OH)₂ passivation layer on the anodes. Overall, 50±1 mT exhibited the highest effect in attaining stable and high OCVs and the lowest self-discharge rates of zinc-bromide batteries.

Chronoamperometry experiments were conducted on the oxidation of bromide ions (0.5 M NaBr, pH adjusted to 5.3 using 0.5 M H₂SO₄ as an electrolyte), at a glassy carbon electrode with a block magnet (˜0.6 T on the surface) below the electrochemical cell. Results showed that, in the absence of a magnetic field, Br₃⁻ ions fell to the bottom of the cell due to gravity. However, in the presence of a magnetic field, the Br₃⁻ ions visibly rotated locally at the electrode surface. Also, increasing the magnetic field strength resulted in the development of a vortex of Br₃⁻ ions near the electrode surface. Further increasing the magnetic field strength resulted in enhanced dispersion of Br₃⁻ ions. The spatial dimensions (e.g., the diameter of Br₃⁻ ion dispersion and location of the vortex with respect to the electrode surface) increased as the magnetic field strength increased. It is believed that when the magnetic field is sufficiently strong, instead of retaining the Br₃⁻ ions close to the cathode surface, the strong magnetic field can promote cross diffusion by increasing the dispersion of Br₃⁻. This observation supported the trend in OCV, self-discharge of zinc-bromide batteries, and Br at. % on the Zn anode under increasing magnetic field strengths.

Cyclic voltammograms (CVs) of example zinc-bromide batteries were recorded to assess the reversibility of the redox process in the presence and absence of an applied magnetic field. A series of CVs were performed with scan rates of 0.1, 0.2, 0.4, 0.6 and 1.2 mV s⁻at 18±2° C. on example zinc-bromide batteries with 0, 10±1, 30±1, 50±1 and 70±1 mT. Results showed that in the absence of a magnetic field at a scan rate of 1.2 mV s⁻¹, the CV profile exhibited an oxidation peak at 1.97 V with a shoulder peak at 2.1 V (peak separation, 130 mV) and one reduction peak at 1.3 V. However, no noticeable shoulder peak was observed during the reduction.

In the presence of 10±1, 30±1 and 50±1 mT magnetic fields, a more prominent oxidation with a shoulder peak and respective two reduction peaks were observed. At 50±1 mT, significant reversibility of the redox peaks was observed. The oxidation peaks were located at 1.88 V and 2.1 V (peak separation, 220 mV) with the respective reduction peaks at 1.45 and 1.15 V (peak separation, 300 mV). By further increasing the magnetic field to 70±1 mT, only one broad peak at 2.1 V was observed. The cell with 50±1 mT exhibited the highest reversibility which implies a significantly favorable and reproducible reaction environment for the Zn/Br₂ redox chemistry. Using the Randles-Sevick equation, the diffusion coefficient of Br₃⁻ ion was obtained from CVs of zinc-bromide batteries with 0, 10±1, 30±1, 50±1 and 70±1 mT applied magnetic fields. The obtained values were 1.02×10⁻⁶, 0.69×10⁻⁶, 0.94×10⁻⁶, 0.54×10⁻⁶ and 0.75×10⁻⁶, respectively.

Cyclic voltammograms were further analyzed to quantify the diffusion-controlled charge and capacitance charge contributions. The capacitive charge is an indication of dissolution and passivation layer formation. Thus, higher diffusion-controlled charge would indicate better reversibility of redox processes. The diffusion-controlled process of the redox reactions was confirmed from the peak current vs. square root of the scan rate plots. The graphical representation is shown in FIG. 3C. FIGS. 3D and 3E show the capacitive charge and diffusion-controlled charge contributions in the CVs of example zinc-bromide batteries with 0 and 50±1 mT at a scan rate of 1.2 mV s⁻¹. As shown in these figures, the capacitive charge was approximately five times lower when using a magnetic field of 50±1 mT, which indicates suppressed dissolution and passivation layer on the electrode surfaces. In the absence of magnetic field, the Br₂ or Br₃⁻¹ ions dissolved from the TPABr₃ complex (i) underwent adsorption (passivation layer) on the electrode layer or inside the pores of electrode carbon and (ii) dissolved away in the electrolyte. Thus, the capacitive charge appeared in the CV profiles. In contrast, in the presence of magnetic fields, the dissolved ions experienced magnetohydrodynamics instead of adsorption. Therefore, the capacitive charge contribution reduced significantly, and the CV showed improved diffusion-controlled charge contribution.

To investigate the underlying redox processes and favorable conditions, the CVs of example zinc-bromide batteries were recorded using (i) 0.5 M ZnBr₂ and (ii) 0.5 M ZnBr₂+0.2 M TPABr electrolytes with 0 and 50±1 mT, as shown in FIG. 3F. The addition of 0.2 M TPABr improved the stability of Br₃⁻ ions compared to that of the Br ions in the aqueous electrolyte. The first wave belonged to the Br⁻ to Br₃⁻ formation and the second wave denotes the Br₃⁻ oxidation. The peak current of stable Br₃⁻ ion formation at 1.85 V increased (first wave) while the Br₃⁻ oxidation at 2.1 V decreased (second wave). Without TPABr, the Br₃⁻ oxidation peak current was higher than that of the Br⁻ to Br₃⁻ formation peak. Also, such opposite changes in the peak currents originated from the stability of Br₃⁻ and Br⁻ ion in 0.5 M ZnBr₂+0.2 M TPABr and 0.5 M ZnBr₂ electrolytes, respectively.

The reversibility of redox processes was improved with 50±1 mT in 0.5 M ZnBr₂±0.2 M TPABr electrolyte. The first oxidation peak current was slightly decreased and shifted anodically. The redox peaks were well reversible and resolved in the CV profile, which implied the Br₃⁻ ion availability near the interface due to Lorentz force and facile oxidation to Br₂. The addition of TPABr stabilized the Br₃⁻ ion, and the presence of the magnetic field generated a spiral flow of the Br₃⁻ ion, and thus maintaining a position closer to the electrode surface. A broad and decreased peak current was observed in 0.5 M ZnBr₂ (without 0.2 M TPABr) electrolyte with 50±1 mT magnetic field. In 0.5 M ZnBr₂ electrolyte, Br₃⁻ ion was a relatively unstable species, and the presence of Lorentz force decreases its diffusion. As a result, Br₃⁻ ion formation was inhibited. Therefore, only one broad and low-intensity peak in the CV was observed.

Retention of Charged Species using Operando UV-Vis Spectroscopy

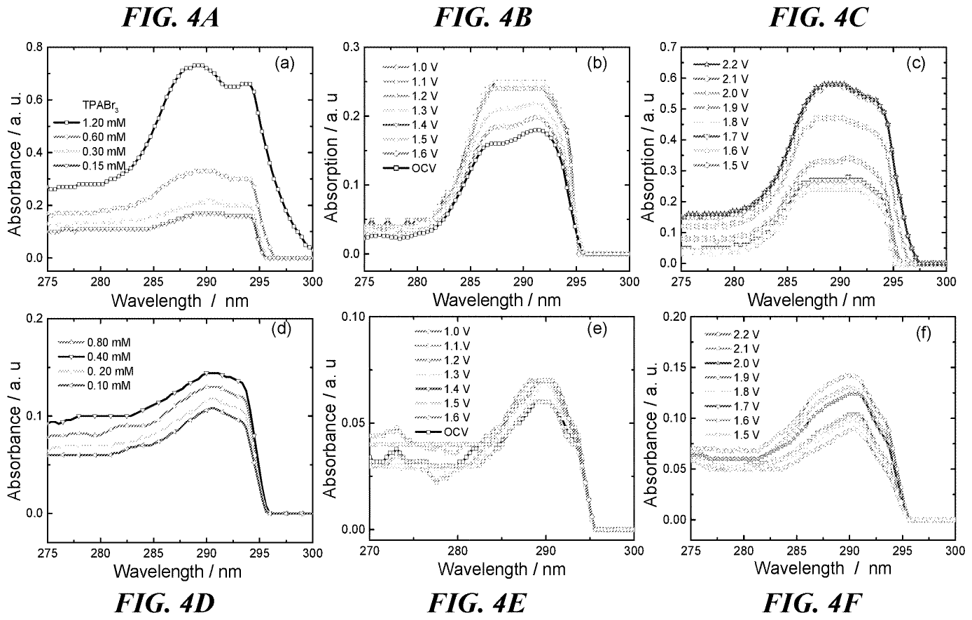

Operando UV-Vis spectroscopy was used to monitor redox products (e.g., Br₂ and Br₃⁻). A series of UV-Vis spectra of the electrolyte were recorded at every 100 mV while running the CV of membrane electrode assembly (“MEA”) at a scan rate of 0.6 mV s⁻¹ and temperature of 18±2° C. with 0 and 50±1 mT, as shown in FIGS. 4B, 4C, 4E and 4F. For reference, UV-Vis spectra of known concentrations of TPABr₃ (0.15, 0.30,0.60 and 1.2 mM) and Br₂ (0.10, 0.20, 0.40 and 0.80 mM) are shown in FIGS. 4A and 4D, respectively.

As shown in FIG. 4A, two absorption peaks were present at 288 and 294 nm for TPABr₃. As the concentration of TPABr₃ increased from 0.15 mM to 1.2 mM, the peak at 288 nm increased faster than that of the 294 nm. The absorption spectrum obtained using the MEA without a magnetic field resembled that of TPABr₃. As shown in FIGS. 4B and 4C, example UV-Vis spectra were recorded during the reduction starting from OCV to 1.0 V followed by oxidation from 1.5 to 2.2 V. During the oxidation process, it is believed that two reactions generated Br₃⁻ and Br₂. Both species are highly soluble and denser than that of the aqueous electrolyte. Two absorption peaks (287.5 and 291.0 nm) appeared and continuously grew in intensity throughout the reduction process.

Like the UV-Vis spectra of TPABr₃, the absorption peak at 287.5 nm increased quicker than that at 291 nm. During the oxidation, the intensity of the absorption peaks increased quicker than during the reduction process. Interestingly, the electrolyte of the MEA with 50±1 mT showed a similar absorption spectrum as Br₂ but contained no signature of TPABr₃. The results appeared to confirm the dissolution of TPABr₃ from the MEA and its severity during the oxidation process of zinc-bromide batteries without a magnetic field. Furthermore, the operando UV-Vis absorption profiles appeared to confirm the ability of Lorentz force to at least reduce the leaching of Br₃-ions.

### Galvanostatic Charge-Discharge Cycling

To evaluate Lorentz force effect on retaining the redox species for enhanced cyclability and voltage efficiency, GCD cycling tests were conducted with 0, 10±1, 30±1, 50±1 and 70±1 mT at 1 C-rate. The pH of 0.5 M ZnBr₂±0.2 M TPABr electrolyte was measured to be 5.4. The cut-off voltages for the charge and discharge processes are set at 2.2 V and 1 V, respectively. Potential cut-offs were chosen to avoid possible water oxidation and complexation during charging and the hydrogen evolution reaction while discharging.

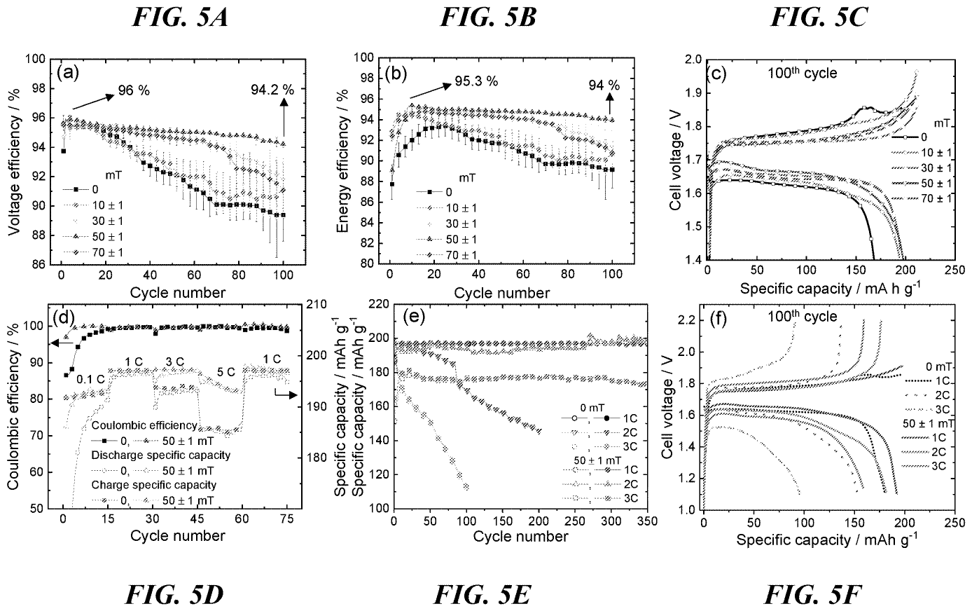

FIG. 5A shows the voltage efficiency of sample cells with 0, 10±1, 30±1, 50±1 and 70±1 mT. As shown in FIG. 5A, the sample cell containing 50±1 mT displayed the highest voltage efficiency of 96±0.5% and exhibited only a small decay of 1.8% after 100 GCD cycles. Initially, the sample cell with 0 mT showed almost the same voltage efficiency as the sample cell with 50±1 mT. However, as the GCD cycling progressed, the voltage efficiency of the sample cell with 0 mT dropped significantly (89.3±2%).

FIG. 5B shows the energy efficiency of sample cells with 0, 10±1, 30±1, 50±1 and 70±1 mT. The energy and voltage efficiencies showed a similar trend in the presence of magnetic fields as discussed in OCV and self-discharge rate studies. FIG. 5C shows the 100^{th} GCD polarization curves of sample cells. As shown in FIG. 5C, the reversible discharge capacity of the sample cell without a magnetic field was found to be ˜84.2 mAh g⁻¹, which is 79.4% of the theoretical specific capacity (119 mAh g⁻¹). On the other hand, sample cells with magnetic fields displayed ˜92% (97.3-98.1 mAh g⁻¹). Also, the voltage hysteresis of the sample cells with applied magnetic fields was remarkably reduced. The voltage hysteresis at 53.3 mAh g⁻¹ was found to be 178, 162, 105, 97 and 118 mV for sample cells with 0, 10±1, 30±1, 50±1 and 70±1 mT, respectively.

As displayed in FIG. 5C, not only improvements in specific capacity and voltage polarization but also sharper ‘knee’ type initial discharge profiles can be observed in sample cells applying magnetic fields. The sharp rise in the charge polarization curve above 1.8 V (around the 100^{th} GCD cycle) is believed to be caused by the high resistance developed due to the insulative TPABr₃ solid complex formation on the activated carbon. The high surface area and high pore volume of carbon support could play a significant role in retaining reversibility and capacity of cells. During discharge, Br₃⁻ and Br₂ released from the TPABr₃ complex underwent reduction. The sharp knee signature of the early discharge curve indicated the improved reversibility of complexation and Br₃⁻/Br₂ release. Thus, the activation loss for the Br₃⁻/Br₂ release appeared to be reduced under the applied magnetic fields.

FIG. 5D shows charge-discharge specific capacities of sample cells with 0 and 50±1 mT at 0.1, 1, 3, 5 and 1 C-rate studies with 15 cycle intervals. As shown in FIG. 5D, the discharge-specific capacity was almost the same for 1 and 3 C-rate (˜98.7 mAh g⁻¹), and at 5 C-rate began declining (˜96.6 mAh g⁻¹) throughout the duration of 15 GCD cycles. The sample cell without magnetic fields exhibited a continuous decrease in the discharge specific capacity from 1 C-rate (98.4 mAh g⁻¹) to 5 C-rate (˜93.1 mAh g⁻¹).

To further evaluate the possible high-rate capability of sample cells with 50±1 mT, 350 GCD cycles were performed on sample cells with 0 and 50±1 mT at 1 C, 2 C, and 3 C-rates. As shown in FIG. 5E, at 1 C-rate, both sample cells displayed stable and approximately equal discharge specific capacities of 98.4 mAh g⁻¹. The cell with 50±1 mT showed a stable discharge capacity for 350 cycles for each C-rate, 1 C (98.9 mAh g⁻¹), 2 C (98.7 mAh g⁻¹) and 3 C-rates (88.8 mAh g⁻¹). The cell without applying a magnetic field showed a gradual discharge specific capacity decay at 2 C (75.6 mAh g⁻¹ at 200^{th} cycle) and severe decay at 3 C-rate (56.1 mAh g⁻¹ at 100th cycle). Also, sample cells with 0 mT survived for only 100, 200 and 100 cycles at 1 C, 2 C and 3 C-rate, respectively.

FIG. 5F compares the 100^{th} GCD cycles and the voltage efficiencies of sample cells with 0 and 50±1 mT at 1 C, 2 C, and 3 C-rates, respectively. As shown in FIG. 5F, incorporating magnetic fields not only improved both the cyclability, energy efficiency, and voltage efficiency, but also allowed for high-rate capabilities in the cells.

### Dendrite-Free Zn Deposition

Dendrite growth is believed to be a challenge for metal-ion batteries or air batteries with metal anodes. Repeated charge-discharge cycling is believed to cause formation of dendritic features in deposited metal. For example, in a zinc-bromine battery, initial deposition of Zn may produce small protrusions on the anode surface. The high surface area of the protrusions and the enhanced negative electric field at the tip of the protrusions attract more Zn²⁺ ions to deposit. Therefore, Zn-dendrites may grow rapidly and could eventually puncture the cell membrane leading to cell failure. In another example, dendrite formation can also be problematic in Li-based batteries since dendrite growth has been shown to result in catastrophic failure of a Li-ion cell (so called ‘thermal runaway’). Also, the high surface area of dendrite tips triggers unwanted reactions with electrolytes causing passivation layer formation and capacity losses.

Additives have been proposed to act as an electrostatic shield on the high-surface-area dendrite tips to reduce formation of the dendritic features. For example, the additive, TPABr with symmetric cation, TPA⁺, is an additive that can reduce the dendrite growth and dissolution. However, experiments showed that the addition of TPABr did not fully arrest the dendrite growth in sample cells.

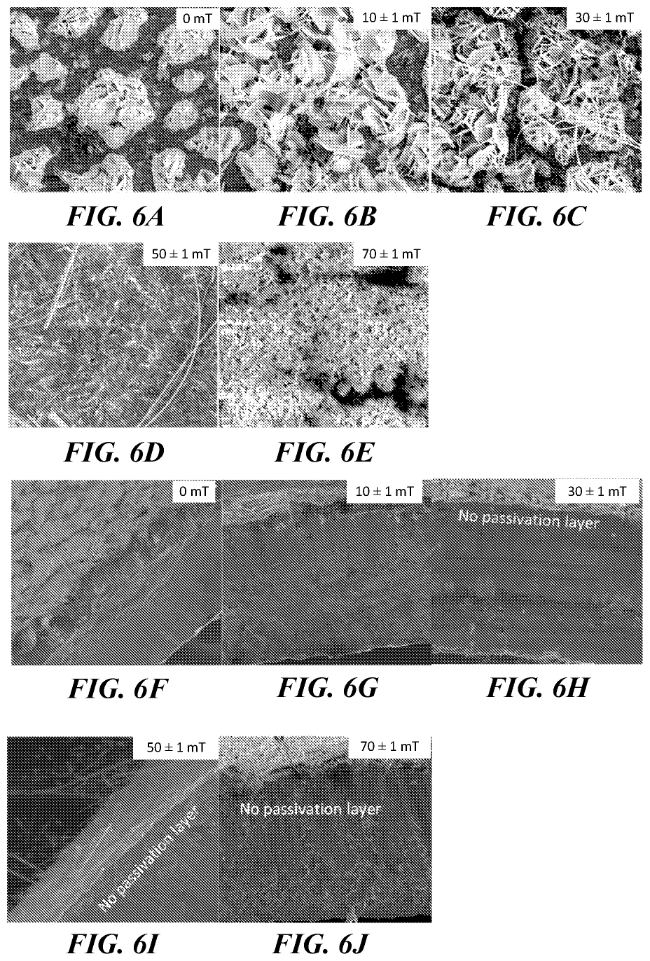

FIGS. 6A-6E and 6F-6J show SEM images of Zn anode surface and cross-sectional views, respectively, after 100 GCD cycles at 1 C-rate of sample cells. FIGS. 6A and 6F show agglomerated Zn-dendrites as 20 μm hexagons and a cross-section of about 45 μm depth, respectively, in a cell without any applied magnetic field. As shown in FIG. 6A, due to the heterogeneity of Zn²⁺ ion concentration and TPA⁺ during the charging process, uneven Zn deposits may be inevitable. As a result of repeated GCD cycling, large hexagonal dendrites were observed to accumulate on the anode surface.

FIG. 6B shows a Zn-dendrite morphology as large as 20 μm in the presence of 10±1 mT in a sample cell. The cross-sectional view in FIG. 6G shows the formation of an approximately 15 μm thick passivation layer. As shown in FIG. 6C and 6H, at 30±1 mT, the size of hexagonal Zn-dendrites was decreased to 10-15 μm. The cross-sectional view shows the slightly porous nature of Zn metal without any obvious passivation layer. As shown in FIG. 6D and 6I, upon further increasing the magnetic field to 50±1 mT, the anode appeared to show a different morphology generally without Zn-dendrite growth and no passivation layer. As shown in FIG. 6E and 6J, upon further increasing the magnetic field to 70±1 mT, the anode appeared to generally no Zn-dendrite growth and no passivation layer. It is believed that the presence of a magnetic field induces Lorentz force on Zn²⁺ ions and disrupts the columbic attraction between freshly formed nucleates and Zn²⁺ ions. As a result, zinc can be deposited onto the anode generally uniformly without forming dendritic structures.

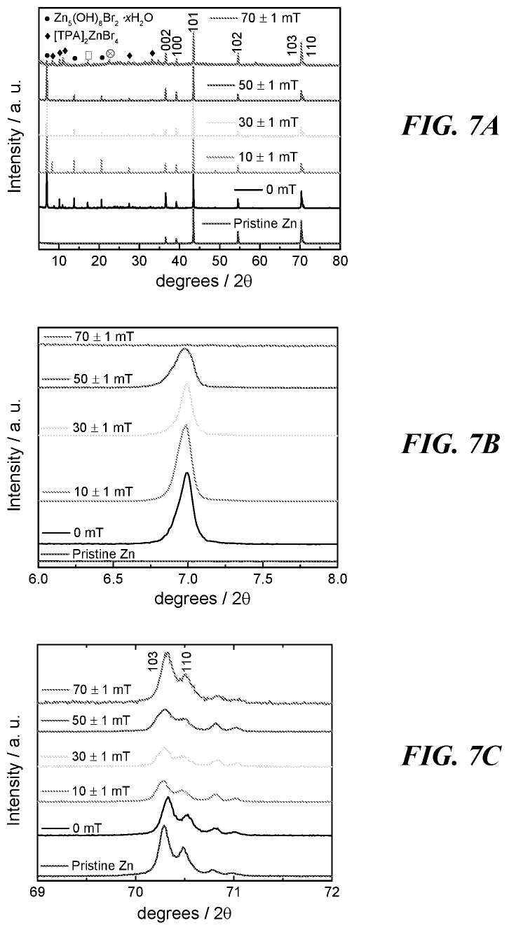

The XRD patterns of Zn anodes of the sample cells after 100 GCD cycles were recorded and presented in FIGS. 7A-7C. The Zn XRD pattern was added for the reference in the FIG. 7A. The XRD reflections of Zn surfaces at 20 values of 36.58, 39.24°, 43.50, 54.62°, and 70.35° were identified as (002), (100), (101), (103) and (110) planes. To attribute the morphological changes due the preferred growth of the planes, the 100% intensity peak at 2θ of 43.50° was normalized to unity. The Zn anode without a magnet showed a relative increase in the intensity of (002) peak, whereas the anodes with 10±1, 30±1 and 50±1 mT showed a decrease in the same peak.

The presence of magnetic fields also appeared to decrease the relative intensity of (103) and (110) planes, as shown in FIG. 7C, compared to that of the pure Zn electrode. Further increasing the magnetic field to 70±1 mT, the Zn surface of anode showed slight relative increase in (002), (103) and (110) planes. The reflection at 2θ values of 6.99° gradually decreased as the magnetic field was increased from 10±1, 30±1 and 50±1 mT and completely disappeared at 70±1 mT, as shown in FIG. 7B. Overall, the cross diffusion of Br⁻ or Br₃⁻ ions appeared to be reduced due to the applied magnetic field and eliminated the formation of Zn₅(OH)₈Br₂·xH₂O complex.

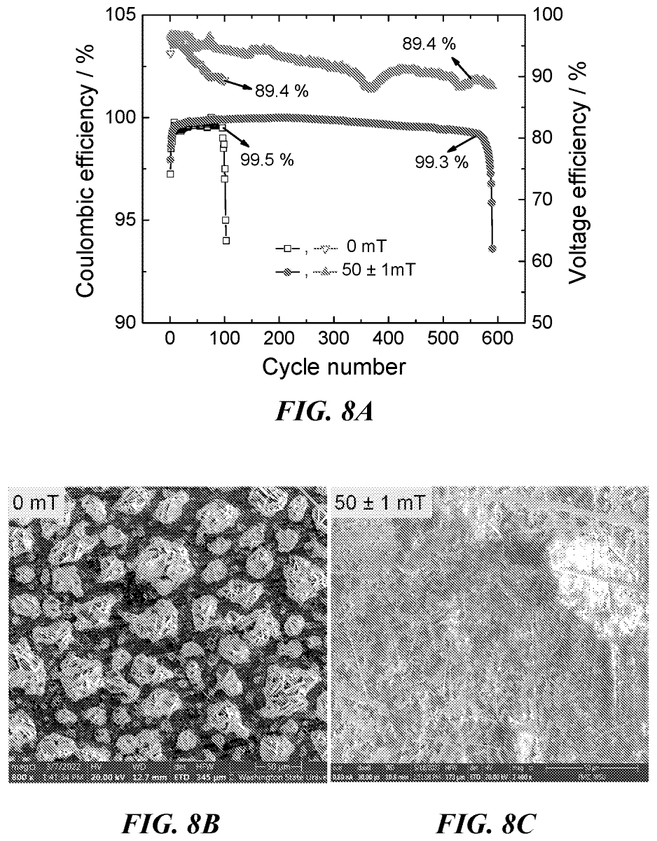

The cycle life of a sample cell with a magnetic field strength of 50±1 mT was measured and compared with a sample cell without a magnetic field. FIG. 8A shows the example cycle life of the sample cells with 0 and 50±1 mT magnetic fields. As shown in FIG. 8A, the sample cell without a magnetic field was able to survive only 100 cycles with delivered 99.5% of electrical efficiency. The sample cell with a 50±1 mT magnetic field performed 550 cycles with a capacity retention of 99.3%. As such, the presence of a magnetic field of 50±1 mT appeared to lead to approximately a 6-fold improvement in cycle life. As shown in FIGS. 8B and 8C, the morphology of Zn anode surfaces of the two sample cells appeared to be completely different. The sample cell with a 50±1 mT magnetic field showed generally dendrite-free Zn deposition even after 590 cycles.

From the results discussed above, it appears that magnetic fields (e.g., 10±1, 30±1, 50±1 and 70±1 mT) from internal magnets can be utilized to provide generally dendrite-free Zn-plating/stripping and at least reduce Br₃⁻/Br₂ cross diffusion in zinc-bromine batteries. Electrochemical analysis, SEM micro-images, EDAX analysis and operando UV-Vis spectroscopy studies appeared to show the effect of Lorentz force on the reversibility of redox processes and the influence on the position/location of chemical species in sample cells. The incorporation of internal magnets, and in turn the generation of Lorentz forces, is an environmentally friendly, low-cost, and zero-energy input approach for improving the performance of not only zinc-bromine batteries but also lithium-ion or other suitable types of metal-ion batteries.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

1. A zinc-bromine battery, comprising:
an aqueous electrolyte containing bromine (Br₂), a plurality of zinc cations (Zn²⁺), and a plurality of anions of bromine, bromine ion complexes, or bromine precursors;
a first electrode containing zinc (Zn);
a second electrode spaced apart from and in fluid communication with the first electrode via the aqueous electrolyte;
a first magnet proximate to a first side of the first electrode, the first magnet having a first field strength to exert sufficient first Lorentz force on at least some of the plurality of zinc cations (Zn²⁺) such that the zinc cations (Zn²⁺) forming a first vortex in the aqueous electrolyte proximate to a surface of a second side of the first electrode during galvanic charging and discharging (GCD) of the zinc-bromine battery, the second side of the first electrode being opposite of the first side of the first electrode; and
a second magnet proximate to a first side of the second electrode and spaced apart from the first magnet by the first electrode and the second electrode, the second magnet having a second field strength to exert sufficient second Lorentz force on at least some of the plurality of anions of bromine such that the anions of bromine forming a second vortex in the aqueous electrolyte proximate to a surface of a second side of the second electrode during GCD of the zinc-bromine battery, the second side of the second electrode being opposite of the first side of the second electrode.

2. The zinc-bromine battery of claim 1, further comprising:
a cell enclosure housing the aqueous electrolyte, the first electrode, and the second electrode; and
where the first magnet and the second magnet are internal to the cell enclosure.

3. The zinc-bromine battery of claim 1, further comprising:
a cell enclosure housing the aqueous electrolyte, the first electrode, and the second electrode; and
where the first magnet and the second magnet are external to the cell enclosure.

4. The zinc-bromine battery of claim 1 wherein:
the first magnet has a North polarity facing the second electrode; and
the second magnet has a North polarity facing the first electrode.

5. The zinc-bromine battery of claim 1 wherein:
the first magnet has a North polarity facing the second electrode; and
the second magnet has a North polarity facing away from the first electrode.

6. The zinc-bromine battery of claim 1 wherein the first vortex at least partially homogenizes a concentration of the zinc cations (Zn²⁺) in the aqueous electrolyte proximate to the surface of the first electrode such that growth of zinc dendrite on the surface of the first electrode is prevented.

7. The zinc-bromine battery of claim 1 wherein the second vortex imparts a spinning motion on the bromide anions in the aqueous electrolyte proximate to the surface of the second electrode such that the anions of bromine are prevented from diffusing toward the first electrode.

8. The zinc-bromine battery of claim 1, further comprising:
a cell membrane in the aqueous electrolyte and between the first and second electrode; and
wherein the first Lorentz force of the first magnet generates a sufficient magnetic flux gradient between the first electrode and the cell membrane such that the zinc cations (Zn²⁺) forming the first vortex in the aqueous electrolyte proximate to the surface of the first electrode during GCD of the zinc-bromine battery.

9. The zinc-bromine battery of claim 1, further comprising:
a cell membrane in the aqueous electrolyte and between the first and second electrode; and
wherein the second Lorentz force of the second magnet generates a sufficient magnetic flux gradient between the second electrode and the cell membrane such that the anions of bromine forming a second vortex in the aqueous electrolyte proximate to a surface of the second electrode during GCD of the zinc-bromine battery.

10. A method of operating a zinc-bromine battery having an aqueous electrolyte containing bromine (Br₂), a plurality of zinc cations (Zn²⁺), and a plurality of anions of bromine, bromine ion complexes, or bromine precursors; a first electrode containing zinc (Zn); a second electrode spaced apart from and in fluid communication with the first electrode via the aqueous electrolyte; a first magnet proximate to a first side of the first electrode;
and a second magnet proximate to a first side of the second electrode and spaced apart from the first magnet by the first and second electrodes and the aqueous electrolyte, wherein the method comprising:
during charging of the zinc-bromine battery,
generating, with the first magnet proximate to the first side of the first electrode, a vortex of the zinc cations (Zn²⁺) near a surface of a second side of the first electrode, the second side of the first electrode being opposite the first side of the first electrode;
with the generated vortex, at least partially homogenizing a concentration of the zinc cations (Zn²⁺) near the surface of the second side of the first electrode; and
reducing at least some of the plurality of zinc cations (Zn²⁺) to deposit zinc onto the surface of the second side of the first electrode without forming zinc dendrites.

11. The method of claim 10, further comprising:
the vortex is a first vortex; and
the method further includes during charging of the zinc-bromine battery, reducing at least some of the anions of bromine in the aqueous electrolyte into bromine (Br₂).

12. The method of claim 10 wherein:
the vortex is a first vortex; and
the method further includes:
with the second magnet proximate to the first side of the second electrode, generating a second vortex of the anions of bromine proximate to a surface of a second side of the second electrode, the second side of the second electrode being opposite the first side of the second electrode; and
restricting or preventing, with the generated second vortex proximate to the surface of the second side of the second electrode, migration of the anions of bromine in the aqueous electrolyte toward the first electrode.

13. The method of claim 10, further comprising:
the vortex is a first vortex; and
the method further includes:
during discharging of the zinc-bromine battery,
converting bromine (Br₂) in the aqueous electrolyte into additional anions of bromine;
with the second magnet proximate to the first side of the second electrode, generating a second vortex of the anions of bromine proximate to a surface of a second side of the second electrode, the second side of the second electrode being opposite the first side of the second electrode; and
restricting or preventing, with the generated second vortex, migration of the additional anions of bromine in the aqueous electrolyte toward the first electrode.

14. The method of claim 10, further comprising:
the vortex is a first vortex; and
the method further includes:
during discharging of the zinc-bromine battery,
dissolving zinc (Zn) at the first electrode into zinc cations (Zn²⁺) and releasing electrons to an external circuit;
receiving, at the second electrode, electrons from the external circuit;
converting, with the received electrons, bromine (Br₂) in the aqueous electrolyte into additional anions of bromine;
with the second magnet proximate to the first side of the second electrode, generating a second vortex of the anions of bromine proximate to a surface of a second side of the second electrode, the second side of the second electrode being opposite the first side of the second electrode; and
restricting or preventing, with the generated second vortex, migration of the additional anions of bromine in the aqueous electrolyte toward the first electrode.

15-20. (canceled)

21. A zinc-bromine battery, comprising:
an aqueous electrolyte containing bromine (Br₂), a plurality of zinc cations (Zn²⁺), and a plurality of anions of bromine, bromine ion complexes, or bromine precursors;
a first electrode containing zinc (Zn);
a second electrode spaced apart from and in fluid communication with the first electrode via the aqueous electrolyte;
a first magnet proximate to a first side of the first electrode, the first magnet having a first field strength to exert sufficient first Lorentz force on at least some of the plurality of zinc cations (Zn²⁺) such that the zinc cations (Zn²⁺) forming a first vortex in the aqueous electrolyte proximate to a surface of a second side of the first electrode during galvanic charging and discharging (GCD) of the zinc-bromine battery, the second side of the first electrode being opposite of the first side of the first electrode;
a second magnet proximate to a first side of the second electrode and spaced apart from the first magnet by the first electrode and the second electrode, the second magnet having a second field strength to exert sufficient second Lorentz force on at least some of the plurality of anions of bromine such that the anions of bromine forming a second vortex in the aqueous electrolyte proximate to a surface of a second side of the second electrode during GCD of the zinc-bromine battery, the second side of the second electrode being opposite of the first side of the second electrode; and
wherein the first magnet and the second magnet individually include a permanent magnetic element that is ferromagnetic.

22. The zinc-bromine battery of claim 21, further comprising:
a cell enclosure housing the aqueous electrolyte, the first electrode, and the second electrode; and
where the first magnet and the second magnet are internal to the cell enclosure.

23. The zinc-bromine battery of claim 21, further comprising:
a cell enclosure housing the aqueous electrolyte, the first electrode, and the second electrode; and
where the first magnet and the second magnet are external to the cell enclosure.

24. The zinc-bromine battery of claim 21 wherein:
the first magnet has a North polarity facing the second electrode; and
the second magnet has a North polarity facing the first electrode.

25. The zinc-bromine battery of claim 21 wherein:
the first magnet has a North polarity facing the second electrode; and
the second magnet has a North polarity facing away from the first electrode.

26. The zinc-bromine battery of claim 21 wherein the first vortex at least partially homogenizes a concentration of the zinc cations (Zn²⁺) in the aqueous electrolyte proximate to the surface of the first electrode such that growth of zinc dendrite on the surface of the first electrode is prevented.
